(19) United States
(12) Patent Application Publication
(10) Pub. No.: US 2024/0172115 A1
(43) Pub. Date: May 23, 2024

(54) RELAYED WAKE-UP SIGNAL FOR AN ACCESS LINK USING A SIDELINK

(71) Applicant: QUALCOMM Incorporated, San Diego, CA (US)

(72) Inventors: Anantharaman BALASUBRAMANIAN, San Diego, CA (US); Shuanshuan WU, San Diego, CA (US)

(21) Appl. No.: 18/057,725

(22) Filed: Nov. 21, 2022

(51) Int. Cl. H04W 52/02; H04W 72/04; H04W 76/28

(52) U.S. Cl. CPC H04W 52/0229; H04W 72/0406; H04W 76/28; H04W 88/04

(57) ABSTRACT

Various aspects of the present disclosure generally relate to wireless communication. In some aspects, a first user equipment (UE) may receive, from a network node and using a first access link, a first indication of an access link wake-up signal associated with a second access link between a second UE and the network node. The first UE may transmit, based at least in part on using a sidelink between the first UE and the second UE, a second indication of the access link wake-up signal to the second UE. Numerous other aspects are described.

### FIELD OF THE DISCLOSURE

Aspects of the present disclosure generally relate to wireless communication and to techniques and apparatuses for a relayed wake-up signal for an access link using a sidelink.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a first user equipment (UE). The method may include receiving, from a network node and using a first access link, a first indication of an access link wake-up signal associated with a second access link between a second UE and the network node. The method may include transmitting, based at least in part on using a sidelink between the first UE and the second UE, a second indication of the access link wake-up signal to the second UE.

Some aspects described herein relate to a method of wireless communication performed by an apparatus of a network node. The method may include transmitting, using a second access link that is associated with a second UE, an instruction to transition the second access link to a deep sleep mode. The method may include transmitting, using a first access link and to a first UE that is associated with a sidelink between the first UE and the second UE, an indication of an access link wake-up signal associated with the second access link.

Some aspects described herein relate to a method of wireless communication performed by an apparatus of a second UE. The method may include receiving, from a network node and using an access link between the second UE and the network node, an instruction to transition the access link to a deep sleep mode. The method may include receiving, from a first UE and using a sidelink between the first UE and the second UE, an indication of an access link wake-up signal associated with the access link.

Some aspects described herein relate to an apparatus for wireless communication at a first UE. The apparatus may include a memory and one or more processors coupled to the memory. The memory may include instructions that are executable by the one or more processors to cause the apparatus to receive, from a network node and using a first access link, a first indication of an access link wake-up signal associated with a second access link between a second UE and the network node. The memory may include instructions that are executable by the one or more processors to cause the apparatus to transmit, based at least in part on using a sidelink between the first UE and the second UE, a second indication of the access link wake-up signal to the second UE.

Some aspects described herein relate to an apparatus for wireless communication at a network node. The apparatus may include a memory and one or more processors coupled to the memory. The memory may include instructions that are executable by the one or more processors to cause the apparatus to transmit, using a second access link that is associated with a second UE, an instruction to transition the second access link to a deep sleep mode. The memory may include instructions that are executable by the one or more processors to cause the apparatus to transmit, using a first access link and to a first UE that is associated with a sidelink between the first UE and the second UE, an indication of an access link wake-up signal associated with the second access link.

Some aspects described herein relate to an apparatus for wireless communication at a second UE. The apparatus may include a memory and one or more processors coupled to the memory. The memory may include instructions that are executable by the one or more processors to cause the apparatus to receive, from a network node and using an access link between the second UE and the network node, an instruction to transition the access link to a deep sleep mode. The memory may include instructions that are executable by the one or more processors to cause the apparatus to receive, from a first UE and using a sidelink between the first UE and the second UE, an indication of an access link wake-up signal associated with the access link.

Some aspects described herein relate to a non-transitory computer-readable medium that stores a set of instructions for wireless communication by an apparatus of a first UE. The set of instructions, when executed by one or more processors of the apparatus, may cause the apparatus to receive, from a network node and using a first access link, a first indication of an access link wake-up signal associated with a second access link between a second UE and the network node. The set of instructions, when executed by the one or more processors, may cause the apparatus to transmit, based at least in part on using a sidelink between the first UE and the second UE, a second indication of the access link wake-up signal to the second UE.

Some aspects described herein relate to a non-transitory computer-readable medium that stores a set of instructions for wireless communication by an apparatus of a network node. The set of instructions, when executed by one or more processors of the apparatus, may cause the apparatus to transmit, using a second access link that is associated with a second UE, an instruction to transition the second access link to a deep sleep mode. The set of instructions, when executed by one or more processors of the apparatus, may cause the apparatus to transmit, using a first access link and to a first UE that is associated with a sidelink between the first UE and the second UE, an indication of an access link wake-up signal associated with the second access link.

Some aspects described herein relate to a non-transitory computer-readable medium that stores a set of instructions for wireless communication by an apparatus of a second UE. The set of instructions, when executed by one or more processors of the apparatus, may cause the apparatus to receive, from a network node and using an access link between the second UE and the network node, an instruction to transition the access link to a deep sleep mode. The set of instructions, when executed by one or more processors of the apparatus, may cause the apparatus to receive, from a first UE and using a sidelink between the first UE and the second UE, an indication of an access link wake-up signal associated with the access link.

Some aspects described herein relate to an apparatus for wireless communication. The apparatus may include means for receiving, from a network node and using a first access link, a first indication of an access link wake-up signal associated with a second access link between a UE and the network node. The apparatus may include means for transmitting, based at least in part on using a sidelink between the apparatus and the UE, a second indication of the access link wake-up signal to the UE.

Some aspects described herein relate to an apparatus for wireless communication. The apparatus may include means for transmitting, using a second access link that is associated with a second UE, an instruction to transition the second access link to a deep sleep mode. The apparatus may include means for transmitting, using a first access link and to a first UE that is associated with a sidelink between the first UE and the second UE, an indication of an access link wake-up signal associated with the second access link.

Some aspects described herein relate to an apparatus for wireless communication. The apparatus may include means for receiving, from a network node and using an access link between the apparatus and the network node, an instruction to transition the access link to a deep sleep mode. The apparatus may include means for receiving, from a UE and using a sidelink between the UE and the apparatus, an indication of an access link wake-up signal associated with the access link.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a discontinuous reception (DRX) configuration, in accordance with the present disclosure.

FIG. 6 is a diagram illustrating an example of a wireless communication process between a network node, a first UE, and one or more other UEs, in accordance with the present disclosure.

FIG. 7 is a diagram illustrating an example of a wireless communication process between a network node, a first UE, and one or more other UEs, in accordance with the present disclosure.

FIG. 8 is a diagram illustrating an example process performed, for example, by a first UE, in accordance with the present disclosure.

FIG. 9 is a diagram illustrating an example process performed, for example, by a network node, in accordance with the present disclosure.

FIG. 10 is a diagram illustrating an example process performed, for example, by a second UE, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

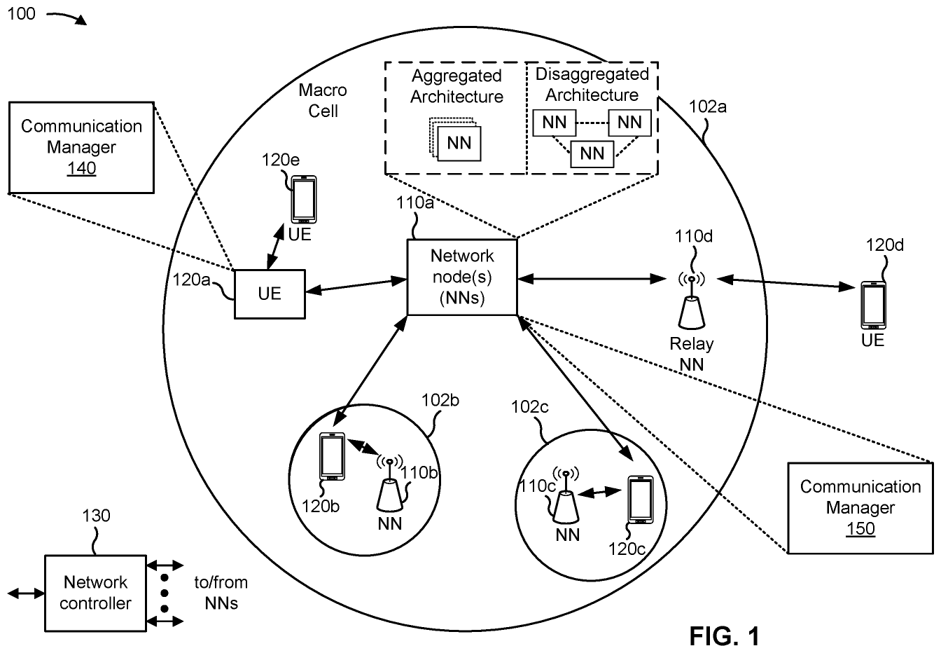

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the UE may be a first UE, and the communication manager 140 may receive, from a network node and using a first access link, a first indication of an access link wake-up signal associated with a second access link between a second UE and the network node; and transmit, based at least in part on using a sidelink between the first UE and the second UE, a second indication of the access link wake-up signal to the second UE. For example, the communication manager 140 may receive the first indication and transmit the second indication based at least in part on the UE acting as a relay UE (e.g., the first UE). Alternatively, or additionally, in some aspects, the UE may be a second UE, and the communication manager 140 may receive, from a network node and using an access link between the second UE and the network node, an instruction to transition the access link to a deep sleep mode; and receive, from a first UE and using a sidelink between the first UE and the second UE, an indication of an access link wake-up signal associated with the access link. To illustrate, the communication manager may receive the instruction from the network node and/or the indication from the first UE based at least in part on the UE acting as the second UE. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit, using a second access link that is associated with a second UE, an instruction to transition the second access link to a deep sleep mode; and transmit, using a first access link and to a first UE that is associated with a sidelink between the first UE and the second UE, an indication of an access link wake-up signal associated with the second access link. Additionally, or alternatively, the communication manager 150 may perform one or more other operations described herein.

As indicated above, FIG. 1 is provided as an example. Other examples may differ from what is described with regard to FIG. 1.

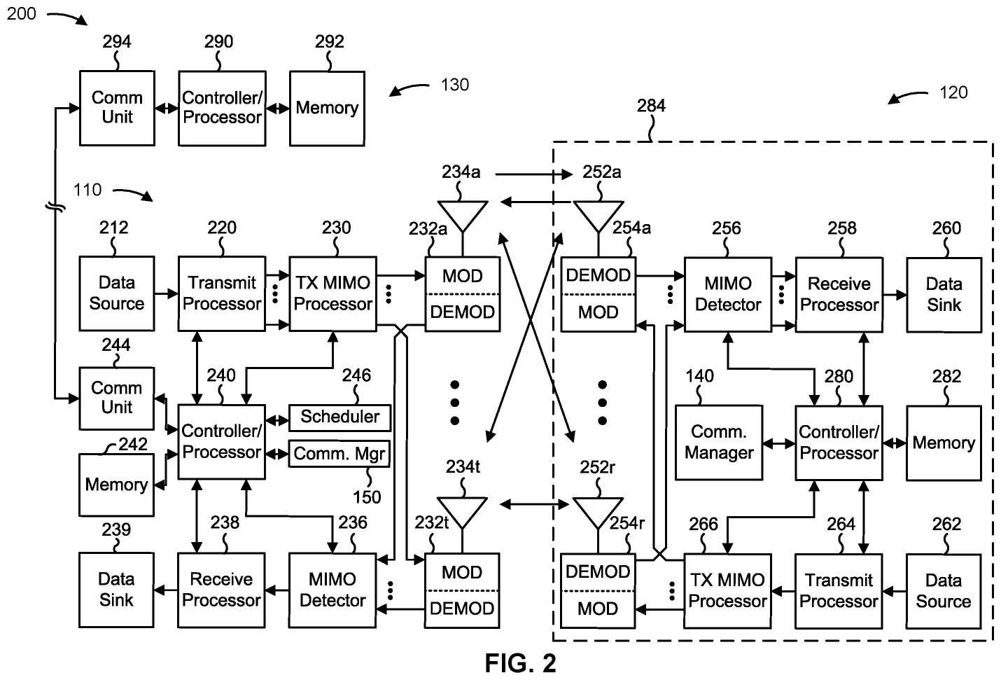

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

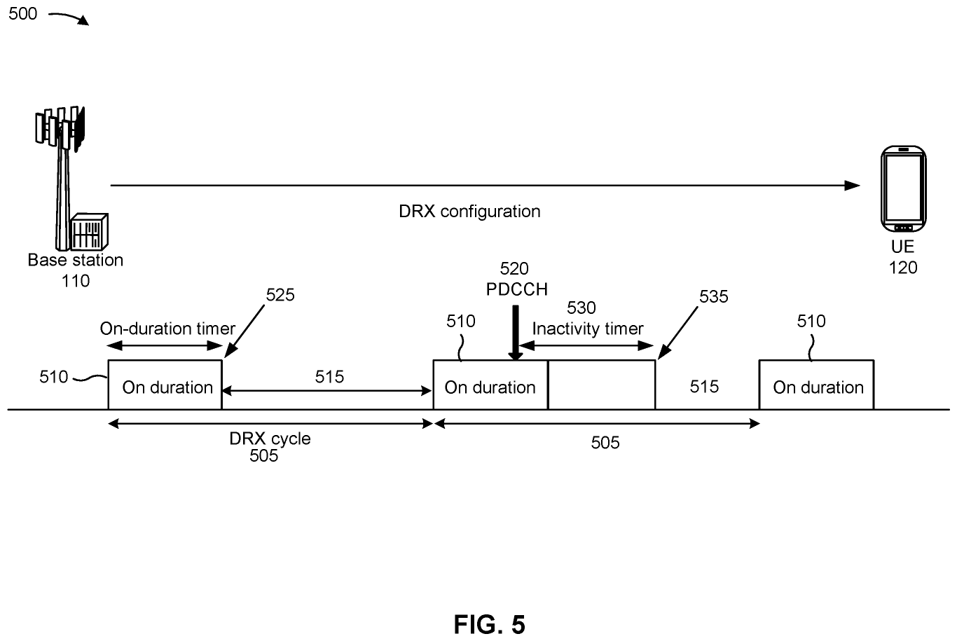

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

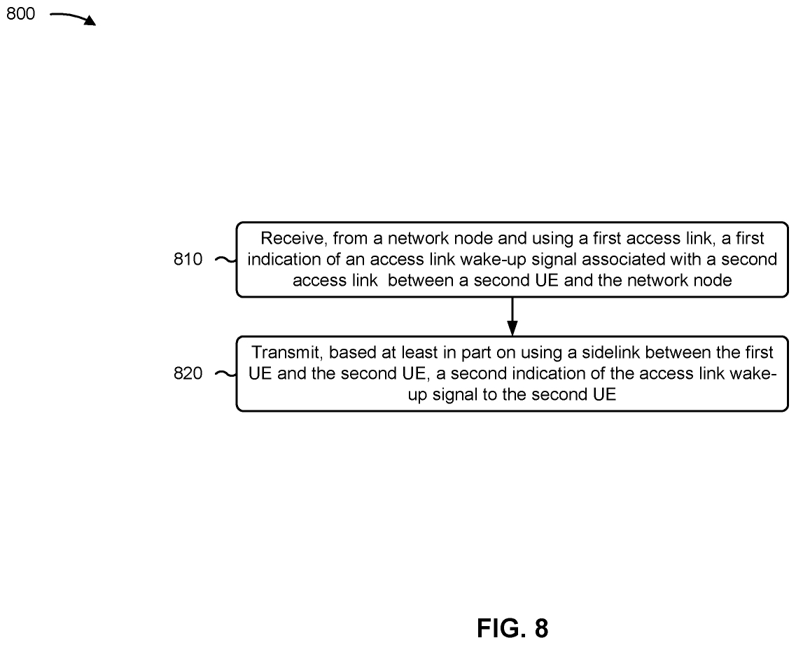

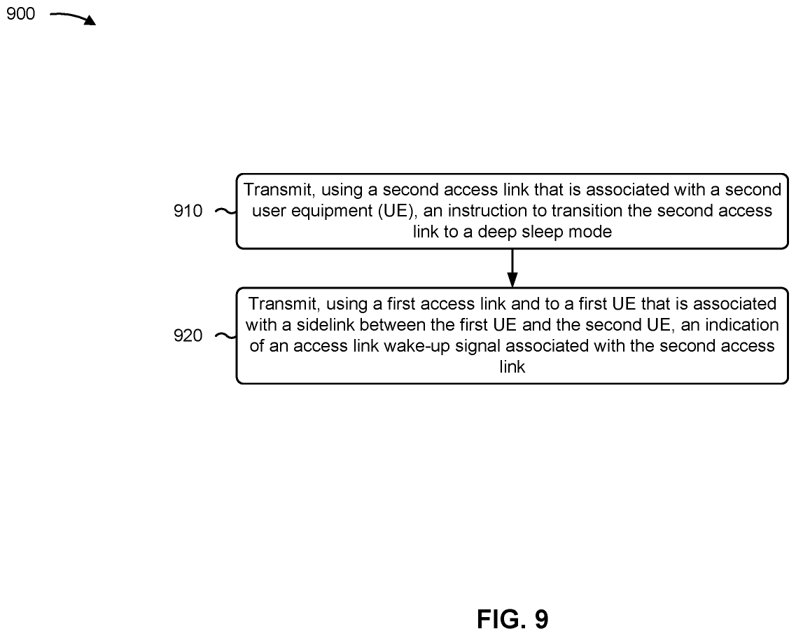

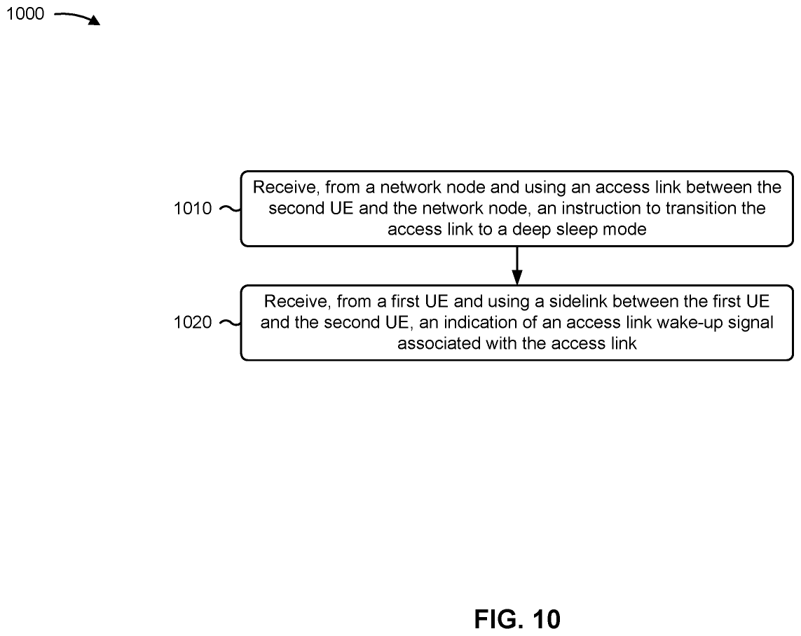

The controller/processor 240 of the network node 110, the controller/processor 280 of the UE 120, and/or any other component(s) of FIG. 2 may perform one or more techniques associated with a relayed wake-up signal for an access link using a sidelink, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node and using a first access link, a first indication of an access link wake-up signal associated with a second access link between a second UE and the network node; and/or means for transmitting, based at least in part on using a sidelink between the UE and the second UE, a second indication of the access link wake-up signal to the second UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving, from a network node and using an access link between the UE and the network node, an instruction to transition the access link to a deep sleep mode; and/or means for receiving, from a first UE and using a sidelink between the first UE and the UE, an indication of an access link wake-up signal associated with the access link. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, using a second access link that is associated with a second UE, an instruction to transition the second access link to a deep sleep mode; and/or means for transmitting, using a first access link and to a first UE that is associated with a sidelink between the first UE and the second UE, an indication of an access link wake-up signal associated with the second access link. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

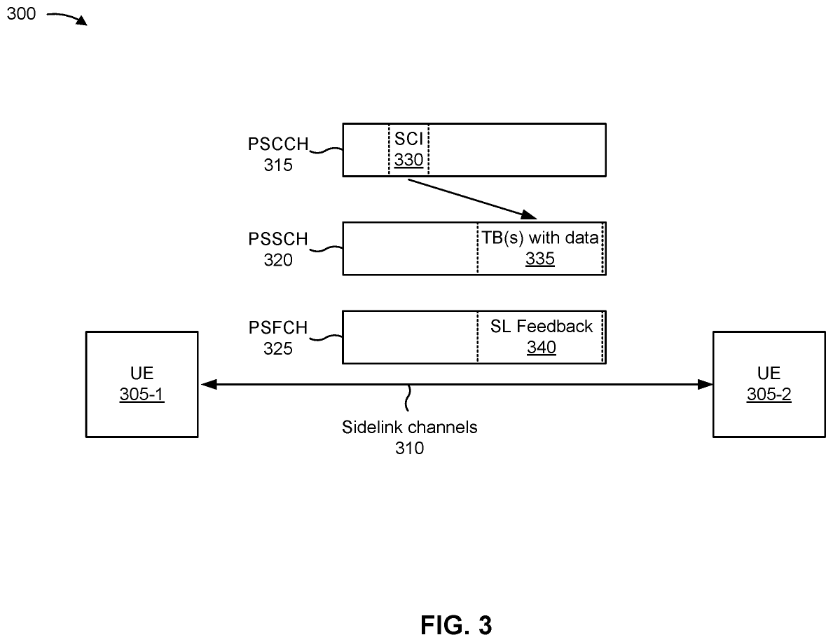

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink resource allocation mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a resource allocation mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the resource allocation mode (e.g., Mode 2) where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

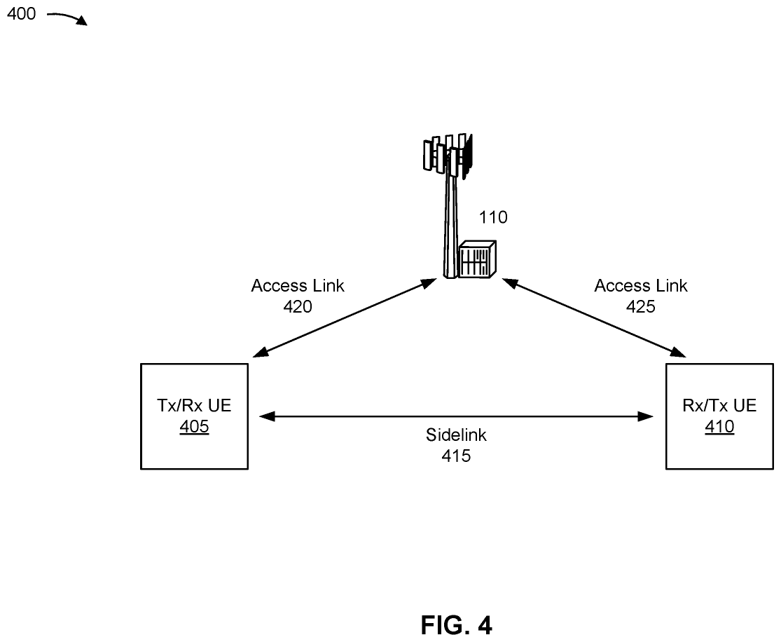

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink 415, as described above in connection with FIG. 3. As further shown, a network node 110 may communicate with the Tx/Rx UE 405 (e.g., directly or via one or more network nodes), such as via a first access link 420. Additionally, or alternatively, in some sidelink modes, the network node 110 may communicate with the Rx/Tx UE 410 (e.g., directly or via one or more network nodes), such as via a second access link 425. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

FIG. 5 is a diagram illustrating an example 500 of a discontinuous reception (DRX) configuration, in accordance with the present disclosure.

Power consumption by a UE may directly affect an operating time duration of the UE. High power consumption by the UE may use battery resources faster than low power consumption, and result in a shorter operating time duration (e.g., relative to an operating time duration associated with low power consumption). In some aspects, the UE may disable and/or transition a communication link to a sleep mode to conserve power.

As shown in FIG. 5, a network node 110 may transmit a DRX configuration to a UE 120 to configure a DRX cycle 505 for the UE 120. To illustrate, a DRX configuration may be associated with an access link between the network node 110 and the UE 120 (e.g., an access link DRX configuration). However, in other examples, a DRX configuration may be associated with a sidelink between UEs (e.g., a sidelink DRX configuration). Accordingly, the network node 110 may transmit an access link DRX configuration and/or a sidelink DRX configuration to the UE 120. Alternatively, or additionally, a first UE 120 may transmit a sidelink DRX configuration to a second UE 120 (e.g., using a sidelink) based at least in part on coordinating sidelink transmissions between the first UE 120 and the second UE 120. For instance, the first UE 120 may configure the second UE 120 with the sidelink DRX configuration and/or the first UE 120 may notify the second UE 120 that the first UE 120 is configured with the sidelink DRX configuration.

A DRX cycle 505 may include a DRX on duration 510 (e.g., during which a UE 120 is awake or in an active state) and an opportunity to enter a DRX sleep state 515. As used herein, the time during which the UE 120 is configured to be in an active state during the DRX on duration 510 may be referred to as an active time, and the time during which the UE 120 is configured to be in the DRX sleep state 515 may be referred to as an inactive time. As described below, the UE 120 may monitor a PDCCH during the active time, and may refrain from monitoring the PDCCH during the inactive time, based at least in part on the DRX cycle 505 being associated with an access link. However, in other aspects, the UE 120 may monitor a PSCCH during the active time, and may refrain from monitoring the PSCCH during the inactive time, based at least in part on the DRX cycle 505 being associated with a sidelink.

During the DRX on duration 510 (e.g., the active time), the UE 120 may monitor a control channel (e.g., a PDCCH or a PSCCH), as shown by reference number 520. For example, the UE 120 may monitor the PDCCH for DCI pertaining to the UE 120, or the PSCCH for SCI pertaining to the UE 120. If the UE 120 does not detect and/or successfully decode any communications (e.g., PDCCH or PSCCH communications) intended for the UE 120 during the DRX on duration 510, then the UE 120 may enter the sleep state 515 (e.g., for the inactive time) at the end of the DRX on duration 510, as shown by reference number 525. In this way, the UE 120 may conserve battery power and reduce power consumption. As shown, the DRX cycle 505 may repeat with a configured periodicity according to the DRX configuration.

In some aspects, the UE 120 may support different sleep states (also referred to as sleep modes). For example, different sleep states may be configured to enable granular adaptation of transmission and/or reception to reduce energy consumption using techniques in time, frequency, spatial, and/or power domains. Alternatively, or additionally, the different sleep states may be associated with different periodicities. To illustrate, the UE 120 may enter a light sleep state that has a first configured periodicity, or a deep sleep state that has a second configured periodicity that is longer relative to the first periodicity. The light sleep state may enable the UE 120 to respond to a wake-up signal more quickly relative to a deep sleep state based at least in part on the light sleep state having a shorter periodicity. The deep sleep state may provide the UE 120 with more power savings relative to the light sleep state based at least in part on the longer periodicity. Accordingly, the light sleep state and the deep sleep state may vary in terms of power consumption.

If the UE 120 detects and/or successfully decodes a communication intended for the UE 120, then the UE 120 may remain in an active state (e.g., awake) for the duration of a DRX inactivity timer 530 (e.g., which may extend the active time). The UE 120 may start the DRX inactivity timer 530 at a time at which the communication is received (e.g., in TTI in which the communication is received, such as a slot or a subframe). The UE 120 may remain in the active state until the DRX inactivity timer 530 expires, at which time the UE 120 may enter the sleep state 515 (e.g., for the inactive time), as shown by reference number 535. During the duration of the DRX inactivity timer 530, the UE 120 may continue to monitor for communications (e.g., PDCCH or PSCCH communications), may obtain a data communication (e.g., on a downlink data channel, such as a PDSCH, or a sidelink data channel, such as a PSSCH) and/or may prepare and/or transmit a communication (e.g., an uplink communication on a PUSCH or a sidelink communication on the PSSCH). The UE 120 may restart the DRX inactivity timer 530 after each detection of a communication for the UE 120 for an initial transmission (e.g., but not for a retransmission). By operating in this manner, the UE 120 may conserve battery power and reduce power consumption by entering the sleep state 515.

In some aspects, a UE 120 may maintain multiple connections at a same time, such as an access link to a network node 110 and a sidelink to another UE 120 as described with regard to FIG. 4. To save power, each connection may be associated with a respective DRX cycle and/or DRX configuration. To illustrate, the UE 120 may transition the access link into a first sleep state (e.g., based at least in part on an access link DRX configuration) and the sidelink into a second sleep state (e.g., based at least in part on a sidelink DRX configuration). In some aspects, each DRX configuration at the UE 120 may have a different DRX cycle, a different periodicity, and/or a different start time relative to other DRX cycles managed by the UE 120, resulting in reduced power savings by the UE 120. For instance, instead of remaining in an inactive mode and/or sleep state between first DRX on durations (e.g., the DRX on duration 510) associated with the first DRX cycle, the UE 120 may transition a second connection to an active state for a second DRX on duration associated with a second DRX cycle. That is, the second DRX on duration associated with the second DRX cycle may occur during a sleep state associated with the first DRX cycle. Accordingly, the UE 120 may transition to the active state twice as often in a scenario associated with the UE 120 managing two DRX cycles that are unaligned, and consume power more rapidly relative to managing a single DRX cycle.

In some aspects, the network node 110 may configure an access link DRX cycle and a sidelink DRX cycle to align the DRX cycles (e.g., align a start time, a DRX cycle, and/or a periodicity). In aligned DRX cycles, the UE 120 may monitor for multiple signals while operating in an active state, such as by monitoring for a PDCCH communication that uses the access link and a PSCCH communication that uses the sidelink connection. Accordingly, the UE 120 enables and/or transitions both connections to an active state, resulting in the UE 120 consuming power more rapidly relative to managing a single DRX cycle. Increased power consumption may result in a reduced life span and/or operating time duration for the UE 120.

Some techniques and apparatuses described herein provide a relayed wake-up signal for an access link using a sidelink. In some aspects, a first UE may receive, from a network node and using a first access link between the first UE and the network node, a first indication of an access link wake-up signal that is associated with a second access link between a second UE and the network node. The first UE may transmit, based at least in part on using a sidelink between the first UE and the second UE, a second indication of the access link wake-up signal to the second UE.

In some aspects, a network node may transmit, using a second access link that is between the network node and a second UE, an instruction to transition the second access link to a deep sleep mode. At a later point in time, the network node may transmit, to a first UE and using a first access link between the network node and the first UE, an indication of an access link wake-up signal associated with the second access link. The network node may transmit the access link wake-up signal to the first UE based at least in part on the first UE having a sidelink to the second UE.

In some aspects, a second UE may receive, from a network node and using an access link between the second UE and the network node, an instruction to transition the access link to a deep sleep mode. At a later time, the second UE may receive, from a first UE and using a sidelink between the first UE and the second UE, an indication of an access link wake-up signal associated with the access link.

By relaying an access link wake-up signal to a second UE using the sidelink, a first UE may enable the second UE to transition an access link between the second UE and a network node to an inactive state for a longer time duration (e.g., based at least in part on a deep sleep state) relative to transitioning the access link to a light sleep state. Alternatively, or additionally, the second UE may retain a responsiveness to an access link wake-up signal based at least in part on a sidelink DRX cycle that is configured with a shorter periodicity relative to the deep sleep state. By relaying the access link wake-up signal, the first UE may also enable the second UE to monitor a single DRX cycle (e.g., a sidelink DRX cycle) while the access link is in a sleep state and/or inactive state (e.g., based at least in part on an access link DRX cycle), reduce power consumption, and increase a life span and/or operating time duration of the second UE. In some aspects, the first UE may have access to an amount of power that satisfies a high power threshold and/or more power relative to the second UE. Accordingly, the first UE may monitor multiple connections and have a longer operating time duration relative to the second UE monitoring multiple connections based at least in part on the differences in power available to each UE. Thus, the first UE may be able to monitor an access link on behalf of the second UE, and the second UE may transition the access link to an inactive mode for a longer time duration, reduce power consumption, and preserve a battery life at the second UE.

As indicated above, FIG. 5 is provided as an example. Other examples may differ from what is described with respect to FIG. 5.

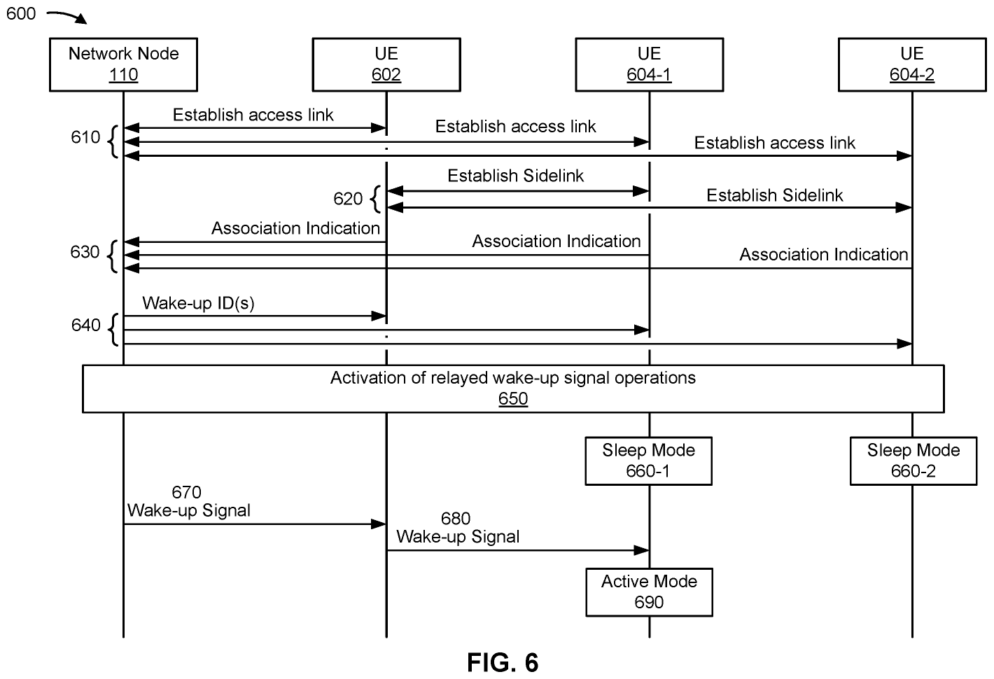

FIG. 6 is a diagram illustrating an example 600 of a wireless communication process between a network node (e.g., the network node 110), a first UE 120 (shown as a first UE 602), and one or more other UEs 120 (shown as a second UE 604-1 and a third UE 604-2), in accordance with the present disclosure. For simplicity, the example 600 shows two other UEs (e.g., the second UE 604-1 and the third UE 604-2) that connect to the first UE 602 (e.g., a high power UE) based at least in part on a sidelink, but other examples may include more or fewer UEs (e.g., one or more low power UEs) that connect to the first UE 602 based at least in part on a sidelink.

In some aspects, the first UE 602 may have access to an amount of power that satisfies a high power threshold and/or more power relative to the second UE 604-1 and/or the third UE 604-2. To illustrate, the first UE 602 may be a vehicle that includes a power generator and/or a first battery with a large power storage capacity (e.g., that satisfies the high power threshold), and the second UE 604-1 and/or the third UE 604-2 may each be a mobile device with a second battery that has lower power storage capacity relative to the first battery. As another example, the first UE may be a mobile device or a laptop and the second UE 604-1 and/or the third UE 604-2 may be a wearable device. Thus, the first UE 602 may be referred to as a high power UE, and the second UE 604-1 and/or the third UE 604-2 may be referred to as a low power UE based at least in part on relative power levels and/or power storage capacity.

As shown by reference number 610, the network node 110 may establish an access link (e.g., a connection to a RAN) with one or more UEs based at least in part on one or more RATs. For example, the network node 110 may establish a first access link with a first UE 602 based at least in part on a first RAT, a second access link with a second UE 604-1 based at least in part on the first RAT or a second RAT, and/or a third access link with a third UE 604-2 based at least in part on the first RAT, the second RAT, and/or a third RAT. To illustrate, the first UE 602, the second UE 604-1, and/or the third UE 604-2 may perform a respective initial access procedure with the network node 110 to gain access to the RAN.

As part of an initial access procedure, each UE may provide the network node 110 with capability information, such as capability information on whether a respective UE supports relayed wake-up operations. In some aspects, a UE, such as the first UE 602, may specify, in the capability information, a permission indication that specifies that the UE agrees to be a relay UE for relayed wake-up operations. “Relayed wake-up operations” may denote a network node 110 transmitting an access link wake-up signal associated with a second UE to a first UE (e.g., using an access link), and/or the first UE relaying the access link wake-up signal to the second UE using a sidelink.

As shown by reference number 620, the first UE 602 may establish a first sidelink with the second UE 604-1 and/or a second sidelink with the third UE 604-2 as described with regard to FIG. 3 and FIG. 4. For example, the first UE 602 may communicate with the second UE 604-1 (e.g., using the first sidelink) and/or the second UE 604-2 (e.g., using the second sidelink) based at least in part on using any combination of a PSCCH, a PSSCH, and/or a PSFCH. Accordingly, each of the first UE 602, the second UE 604-1, and/or the third UE 604-2 may maintain at least two wireless connections: an access link with the network node 110 and a sidelink connection with another UE as described with regard to FIG. 4.

As shown by reference number 630, the first UE 602, the second UE 604-1, and/or the third UE 604-2 may transmit, and the network node 110 may receive, an association indication. To illustrate, the first UE 602 may transmit a first association indication to the network node using the first access link, and the first association indication may specify that the first UE 602 is associated with the second UE 604-1 and the third UE 604-1. Alternatively, or additionally, the second UE 604-1 may transmit. using the second access link, a second association indication to the network node, and the second association indication may specify that the second UE 604-1 is associated with the first UE 602. In some aspects, the third UE 604-2 may transmit a third association indication to the network node using the third access link, and the third association indication may specify that the third UE 604-2 is associated with the first UE 602.

Any combination of the first association indication, the second association indication, and/or the third association indication may include and/or specify a respective UE identifier for each UE associated with the transmitting UE. In some aspects, the UE identifier may be based at least in part on a sidelink identifier and/or a network identifier. As one example, the sidelink identifier may include a Layer 1 sidelink identifier, a Layer 2 sidelink identifier, and/or a Layer 3 identifier. The network identifier may include an international mobile subscriber identity (IMSI) and/or an s-temporary mobile subscriber identity (s-TMSI).

To illustrate, the first UE 602 may specify and/or include, in the first association indication, a UE identifier associated with the second UE 604-1 and/or a UE identifier associated with the third UE 604-2 based at least in part on the first UE 602 establishing a sidelink with the second UE 604-1 and/or the third UE 604-2. The second UE 604-1 may specify and/or include, in the second association indication, a UE identifier associated with the first UE 602. Alternatively, or additionally, the second UE 604-1 may exclude, from the second association indication, the UE identifier associated with the third UE 604-2 based at least in part on not establishing a sidelink with the third UE 604-2. The third UE 604-2 may specify and/or include, in the third association indication, a UE identifier associated with the first UE 602 and/or exclude, from the third association indication, the UE identifier associated with the second UE 604-1. In some aspects, the transmitting UE of the associated indication may include, in the association indication, a network identity associated with the transmitting UE and a sidelink identity associated with the associated UE.

Each association indication may specify that the association is based at least in part on a sidelink. That is, an association indication may explicitly and/or implicitly specify that the two UEs have established a sidelink between one another. For instance, the association indication may include and/or specify a bit field that indicates a sidelink association when set to a first value (e.g., “1”) and indicates that there is no sidelink association when set to a second value (e.g., “0”). To illustrate, the second UE 604-1 may include, in the second association indication, a UE identifier associated with the first UE 602 and set a first bitfield to the first value to indicate a sidelink association. Alternatively, or additionally, the second UE 604-1 may include, in the second association indication, a UE identifier associated with the third UE 604-2 and set a second bitfield to the second value to indicate there is no sidelink association. However, in some aspects, the second UE 604-1 may exclude the UE identifier associated with the third UE 604-2 and implicitly indicate that there is no sidelink association. Thus, the inclusion and/or exclusion of a UE identifier may implicitly indicate whether the UEs have a sidelink association.

As part of the first association indication, the first UE 602 may transmit, to the network node, a permission indication that specifies that the first UE agrees to be a relay UE for relayed wake-up operations. As one example, the first association indication may specify the permission indication and/or that the first UE agrees to be the relay UE. However, the first UE 602 may transmit the permission indication separately from the first association indication, such as in capability information and/or a different transmission.

As shown by reference number 640, the network node 110 may transmit, and one or more of the first UE 602, the second UE 604-1, and/or the third UE 604-2 may receive, a wake-up identifier. As one example, the network node 110 may transmit (e.g., using the first access link) one or more wake-up identifiers to the first UE 602, such as a first wake-up identifier associated with the second UE 604-1 and/or a second wake-up identifier associated with the third UE 604-2. Alternatively, or additionally, the network node 110 may transmit the respective wake-up identifier to the respective UE, such as by transmitting the first wake-up identifier to the second UE 604-1 (e.g., using the second access link) and/or the second wake-up identifier to the third UE 604-2 (e.g., using the third access link). As shown by the example 600, the network node 110 may transmit and/or assign a wake-up identifier to a UE prior to activating relayed wake-up operations and/or prior to transmitting an access link wake-up signal to the first UE 602 for relaying.

In some aspects, the network node 110 may transmit, as the wake-up identifier, a temporary identifier that is associated with relayed wake-up operations and/or a temporary identifier that obscures a network identity of an assigned UE (e.g., the second UE 604-1 and/or the third UE 604-2). To illustrate, the temporary identifier associated with the relayed wake-up operations may obscure an IMSI associated with the UE and/or an s-TMSI associated with the UE. Alternatively, or additionally, the wake-up identifier may be based at least in part on a mapping to an access link identifier (e.g., a network identity) and/or a sidelink identifier. For instance, the wake-up identifier may be mapped to a Layer 1 sidelink identifier, a Layer 2 sidelink identifier, and/or a Layer 3 sidelink identifier. Alternatively, or additionally, the wake-up identifier may be an encoded sidelink identifier and/or encoded access link identifier. A receiving device may decode the wake-up identifier and/or use the mapping to obtain the access link identifier and/or the sidelink identifier.

As shown by reference number 650, the network node 110 may transmit, and one or more of the first UE 602, the second UE 604-1, and/or the third UE 604-2 may receive, a relay mode indication that indicates activation of relayed wake-up operations. In some aspects, the activation of relayed wake-up operations may implicitly instruct the second UE 604-1, and/or the third UE 604-2 to transition an access link to a deep sleep mode as described with regard to FIG. 5. Alternatively, or additionally, the network node 110 may explicitly indicate to transition the access link to a deep sleep mode, either in a separate transmission from the relay mode indication or as part of the relay mode indication. The network node 110 may transmit the instruction to transition to the deep sleep mode based at least in part on any combination of an RRC message, a medium access control (MAC) control element (CE), and/or DCI.

The instruction to transition to the deep sleep mode and/or the activation of relayed wake-up operations, whether implicit or explicit, may indicate to enable DRX operations for the access link (e.g., access link DRX operations). Alternatively, or additionally, the instruction to transition the access link to the deep sleep mode may implicitly or explicitly indicate to retain a sidelink between UEs and/or to refrain from transitioning the sidelink to a deep sleep mode. In some aspects, an access link DRX configuration may be different from a sidelink DRX configuration. For example, a periodicity associated with the access link DRX configuration may be independent of a periodicity associated with the sidelink DRX configuration. To illustrate, an access DRX periodicity associated with the access DRX operations may be longer than the sidelink DRX periodicity and/or may not be an integer multiple of the sidelink DRX periodicity. As another example, a start time associated with the access link DRX configuration may be unaligned with a start time associated with the sidelink DRX configuration. As yet another example, the access link DRX configuration may be based at least in part on a deep sleep mode and the sidelink DRX configuration may be based at least in part on a light sleep mode. Accordingly, the second UE 604-1 and/or the third UE 604-2 may perform first DRX operations for the access link (e.g., access link DRX operations) and second DRX operations for a sidelink (e.g., sidelink DRX operations).

In some aspects, the network node 110 may transmit, with and/or as part of the relay mode indication, one or more UE identifiers associated with the relayed wake-up operations, such as a UE identifier associated with a relay UE (e.g., a sidelink identifier and/or a wake-up identifier). That is, the network node 110 may indicate an identity of the relay UE. As shown by the example 600, the first UE 602, the second UE 604-1, and/or the third UE 604-2 may receive the relay mode indication prior to receiving an indication of an access link wake-up signal.

As shown by reference number 660-1 and reference number 660-2, respectively, the second UE 604-1, and/or the third UE 604-2 may transition a respective access link into the deep sleep mode based at least in part on receiving the relayed mode indication associated with the activation of the relayed wake-up operations. That is, the activation of the relayed wake-up operations may implicitly indicate to transition an access link to a deep sleep mode. Alternatively, or additionally, the second UE 604-1, and/or the third UE 604-2 may transition the respective access link into the deep sleep mode based at least in part on receiving an explicit instruction to transition the access link to the deep sleep mode (e.g., with the relayed mode indication or in a separate transmission). In some aspects, the second UE 604-1, and/or the third UE 604-2 may transition the access link to a deep sleep mode based at least in part on an access link DRX configuration (e.g., an access link DRX periodicity) indicated by the network node 110 and/or based at least in part on an access link DRX configuration specified by a communication standard. In some aspects, the second UE 604-1, and/or the third UE 604-2 may transition the sidelink connection to a light sleep mode that has a shorter DRX periodicity relative to the deep sleep mode. In other examples, the second UE 604-1 may transition the respective access link to the deep sleep mode and the third UE 604-2 may keep the respective access link in an active mode (or vice versa). Thus, the second UE 604-1, and/or the third UE 604-2 may transition a respective access link into the deep sleep mode independent of whether the other UE retains the access link in the active mode or transitions the respective active link to the deep sleep mode. Alternatively, or additionally, a UE may transition an access link to a deep sleep mode independent of whether a sidelink is active or is transitioning to a sleep mode (e.g., light or deep).

As shown by reference number 670, the network node 110 may transmit, and the first UE 602 may receive, a wake-up signal associated with activating an access link (e.g., an access link wake-up signal) and/or transitioning the access link from a sleep mode (e.g., a deep sleep mode and/or an inactive mode) to an active mode. As one example, the network node 110 may transmit an access link wake-up signal to the first UE 602 and indicate to relay the access link wake-up signal to a target UE (e.g., the second UE 604-1 or the third UE 604-2). That is, the network node 110 may transmit, to the first UE 602 and using the first access link, an access link wake-up signal that is associated with another UE and/or another access link. For example, the network node 110 may indicate, using the access link wake-up signal, a UE identifier (e.g., a wake-up identifier or a sidelink identifier) associated with the second UE 604-1 or the third UE 604-2.

As shown by reference number 680, the first UE 602 may transmit, and a target UE (shown as the second UE 604-1) may receive, an access link wake-up signal and/or an indication of the access link wake-up signal. As one example, the first UE 602 may use a mapping that maps the wake-up identifier to a sidelink identifier associated with the target UE, and the first UE 602 may transmit the access link wake-up signal to the target UE based at least in part on the sidelink. Alternatively, or additionally, the first UE 602 may decode the wake-up identifier to obtain the sidelink identifier (e.g., a Layer 1 sidelink identifier, a Layer 2 sidelink identifier, and/or a Layer 3 sidelink identifier) associated with the target UE. In some aspects, the first UE 602 may relay the access link wake-up signal and/or transmit an indication of the access link wake-up signal based at least in part on a sidelink DRX cycle associated with the target UE such that the target UE receives the access link wake-up signal (and/or the indication of the access link wake-up signal) at a time duration associated with a DRX on duration (e.g., a sidelink DRX on duration associated with the target UE).

In some aspects, the first UE 602 may transmit, and the target UE may receive, a sidelink wake-up signal that indicates an access link wake-up signal has occurred. To illustrate, the sidelink wake-up signal may include an explicit indication that the sidelink wake-up signal is associated with the access link between the target UE and the network node 110 (e.g., the second access link). That is, the first UE 602 may refrain from transmitting an explicit access link wake-up signal to the target UE (e.g., via the sidelink), and instead, may transmit a sidelink wake-up signal to the target UE. The sidelink wake-up signal may include an explicit indication that the sidelink wake-up signal is associated with the access link. To illustrate, the sidelink wake-up signal may include a bit field, and the first UE 602 may set a bit in the bitfield to a value (e.g., “1” or “0”) that indicates the sidelink wake-up signal is associated with the access link.

As shown by reference number 690, the target UE (shown as the second UE 604-1) may transition an access link to an active mode. For instance, the target UE may decode a wake-up identifier from an access link wake-up signal and/or a sidelink wake-up signal. The target UE may identify that the wake-up identifier is associated with the target UE and an access link, and transition the access link to an active mode.

By relaying an access link wake-up signal to a second UE using the sidelink, a first UE may enable the second UE to transition an access link between the second UE and a network node to an inactive state for a longer time duration (e.g., a deep sleep state) relative to transitioning the access link to a light sleep state. Alternatively, or additionally, the second UE may retain a responsiveness to an access link wake-up signal based at least in part on a sidelink DRX cycle that is configured with a shorter periodicity relative to the deep sleep state. By relaying the access link wake-up signal, the first UE may also enable the second UE to monitor a single DRX cycle (e.g., a sidelink DRX cycle) while the access link is in a sleep state and/or inactive state (e.g., based at least in part on an access link DRX cycle), reduce power consumption, and increase a life span and/or operating time duration of the second UE.

As indicated above, FIG. 6 is provided as an example. Other examples may differ from what is described with regard to FIG. 6.

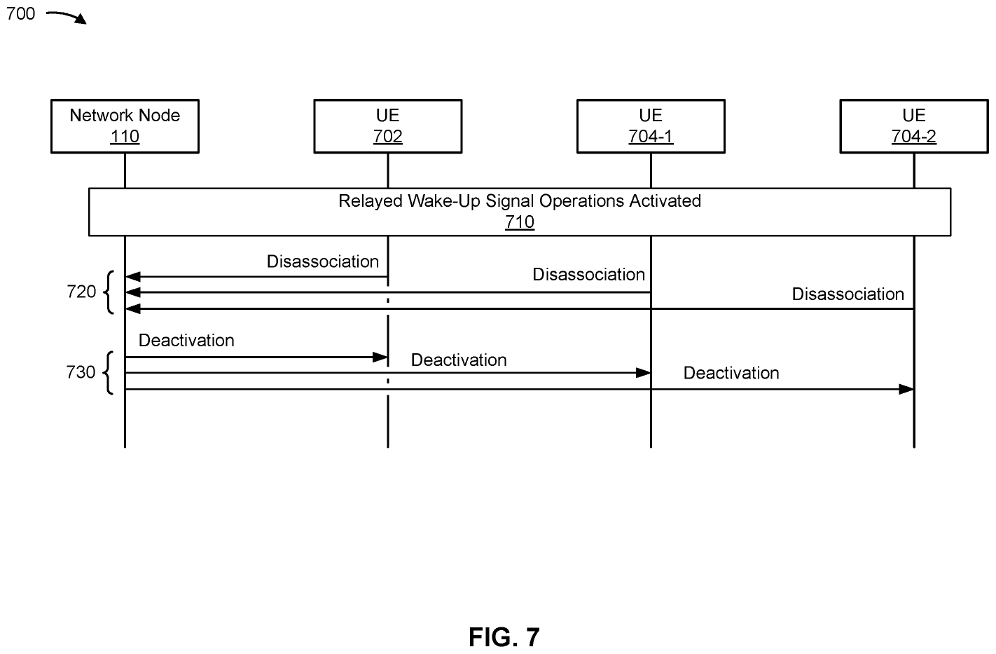

FIG. 7 is a diagram illustrating an example 700 of a wireless communication process between a network node (e.g., the network node 110), a first UE 120 (shown as a first UE 702), and one or more other UEs 120 (shown as a second UE 704-1 and a third UE 704-2), in accordance with the present disclosure. For simplicity, the example 700 shows two other UEs (e.g., the second UE 704-1 and the third UE 704-2) that connect to the first UE 702 (e.g., a high power UE) based at least in part on a sidelink, but other examples may include more or fewer UEs (e.g., one or more low power UEs) that connect to the first UE 702 based at least in part on a sidelink.

As shown by reference number 710, any combination of the network node 110, the first UE 702, the second UE 704-1, and/or the third UE 704-2 may operate based at least in part on relayed wake-up signal operations being activated as described with regard to the example 600. For example, the first UE 702, the second UE 704-1, and/or the third UE 704-2 may establish a respective access link with the network node 110 as described with regard to reference number 610. Alternatively, or additionally, the first UE 702 may establish a respective sidelink with the second UE 704-1 and/or the third UE 704-2 as described with regard to reference number 620. The network node 110 may transmit a relayed mode indication associated with the activation of the relayed wake-up operations as described with regard to reference number 650. The relayed mode indication associated with the activation of the relayed wake-up operations may be based at least in part on the network node 110 receiving one or more association indications as described with regard to reference number 630 and/or the network node 110 transmitting one or more wake-up identifiers as described with regard to reference number 640.

As shown by reference number 720, the first UE 702, the second UE 704-1, and/or the third UE 704-2 may transmit, and the network node 110 may receive, a disassociation indication. A “disassociation indication” may specify that two UEs that were previously associated with one another (e.g., through a sidelink) are no longer associated with one another. As one example, the first UE 702 may transmit, using a first access link between the first UE 702 and the network node 110, a first disassociation indication that specifies the first UE and the second UE are disassociated. The first UE 702 may indicate, using the first disassociation indication, a wake-up identifier (e.g., a temporary identifier and/or a sidelink identifier) assigned to the second UE. Alternatively or additionally, the second UE 704-1 may transmit a second disassociation indication to the network node 110 and/or the third UE 704-2 may transmit a third disassociation indication to the network node 110. To illustrate, the second UE 704-1 and/or the third UE 704-2 may transmit a disassociation indication to the network node 110 based at least in part on a random access channel (RACH) transmission and/or a grant-less transmission. In some aspects, a disassociation indication may specify a reason for the disassociation. For example, the second UE 704-1 may indicate that a sidelink between the first UE 702 and the second UE 704-1 has been torn down, terminated, and/or lost. To illustrate, the first UE 702, the second UE 704-1, and/or the third UE 704-2 may move out of operating range (e.g., for a sidelink) of one or more other UE. For clarity, the example 700 shows the first UE 702, the second UE 704-1, and the third UE 704-2 transmitting the disassociation indication directly to the network node 110. However, in other examples, the second UE 704-1, and/or the third UE 704-2 may transmit a disassociation indication to the first UE 702 based at least in part on a respective sidelink, and the first UE 702 may relay the disassociation indication to the network node 110 based at least in part on an access link. For instance, the second UE 704-1 may transmit the disassociation indication to the first UE 702 using the sidelink and as part of a procedure that tears down the sidelink, and the first UE 702 may relay the disassociation indication to the network node 110.

As shown by reference number 730, the network node 110 may transmit, and the first UE 702, the second UE 704-1, and/or the third UE 704-2 may receive, a relay mode indication that specifies deactivation of the relayed wake-up signal operations. That is, the relay mode indication may instruct the first UE 702, the second UE 704-1, and/or the third UE 704-2 to deactivate relayed wake-up signal operations. To illustrate, the network node 110 may transmit a relay mode indication to the first UE based at least in part on using a first access link (e.g., between the network node 110 and the first UE 702), a second relay mode indication to the second UE 704-1 using a second access link (e.g., between the network node 110 and the second UE 704-1), and/or a third relay mode indication to the third UE 704-2 based at least in part on using a third access link (e.g., between the network node 110 and the third UE 704-2). In some aspects, the first UE 702 may refrain from relaying an access link wake-up signal to the second UE 704-1 and/or the third UE 704-2 based at least in part on receiving the relay mode indication associated with deactivation of the relayed wake-up operations. Alternatively, or additionally, the second UE 704-1 and/or the third UE 704-2 may transmit a respective access link to an active mode and/or a light sleep mode based at least in part on receiving the relay mode indication associated with deactivation of the relayed wake-up operations.

For clarity, the example 700 shows the network node 110 transmitting a respective relayed mode indication (e.g., associated with the deactivation of relayed wake-up signal operations) to the first UE 702, the second UE 704-1, and the third UE 704-2 based at least in part on a respective access link associated with each UE. However, in other examples, the network node 110 may transmit the relayed mode indication associated with the deactivation of relayed wake-up signal operations to the first UE 702 based at least in part on using an access link, and the first UE 702 may relay the relayed mode indication to the second UE 704-1, and/or the third UE 704-2 based at least in part on using a respective sidelink.

As indicated above, FIG. 7 is provided as an example. Other examples may differ from what is described with regard to FIG. 7.

FIG. 8 is a diagram illustrating an example process 800 performed, for example, by a first UE (e.g., UE 120 and/or first UE 602), in accordance with the present disclosure. Example process 800 is an example where the first UE (e.g., UE 120 and/or first UE 602) performs operations associated with a relayed wake-up signal for an access link using a sidelink.

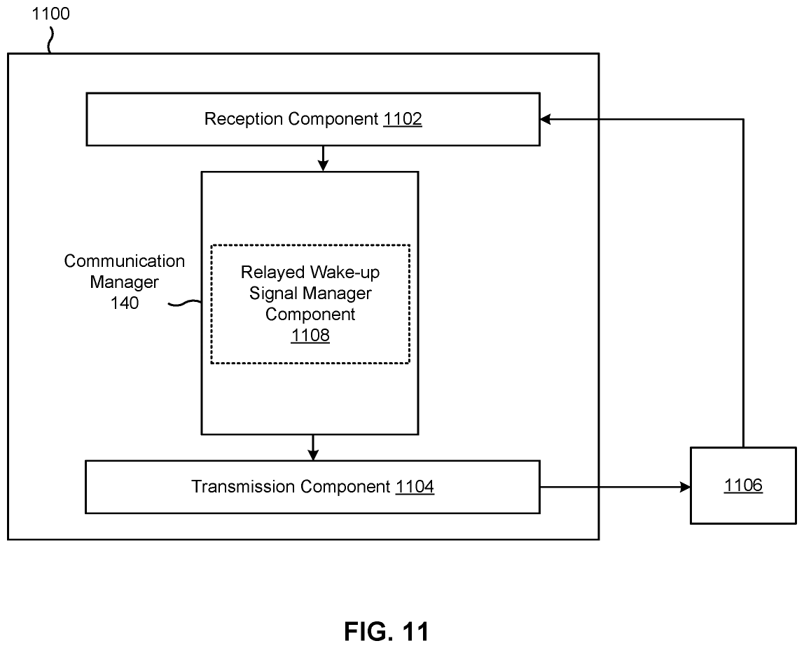

As shown in FIG. 8, in some aspects, process 800 may include receiving, from a network node and using a first access link, a first indication of an access link wake-up signal associated with a second access link between a second UE and the network node (block 810). For example, the first UE (e.g., using communication manager 140 and/or reception component 1102, depicted in FIG. 11) may receive, from a network node and using a first access link, a first indication of an access link wake-up signal associated with a second access link between a second UE and the network node, as described above.

As further shown in FIG. 8, in some aspects, process 800 may include transmitting, based at least in part on using a sidelink between the first UE and the second UE, a second indication of the access link wake-up signal to the second UE (block 820). For example, the first UE (e.g., using communication manager 140 and/or transmission component 1104, depicted in FIG. 11) may transmit, based at least in part on using a sidelink between the first UE and the second UE, a second indication of the access link wake-up signal to the second UE, as described above.

Process 800 may include additional aspects, such as any single aspect or any combination of aspects described below and/or in connection with one or more other processes described elsewhere herein.

In a first aspect, process 800 includes receiving, using the first access link and prior to receiving the access link wake-up signal from the network node, a wake-up identifier assigned to the second UE.

In a second aspect, the wake-up identifier includes a temporary identifier that obscures a network identity assigned to the second UE.

In a third aspect, the network identity includes at least one of an international mobile subscriber identity, or an s-temporary mobile subscriber identity.

In a fourth aspect, the second indication specifies the wake-up identifier.

In a fifth aspect, the wake-up identifier is based at least in part on a mapping between an access link UE identifier and a sidelink identifier, and process 800 includes decoding the wake-up identifier to obtain the sidelink identifier, and transmitting the second indication of the access link wake-up signal to the second UE includes transmitting the second indication of the access link wake-up signal to the second UE based at least in part on using the sidelink identifier.

In a sixth aspect, the sidelink identifier is a Layer 1 sidelink identifier, a Layer 2 sidelink identifier, or a Layer 3 sidelink identifier.

In a seventh aspect, the second indication of the access link wake-up signal includes a sidelink wake-up signal that includes an explicit indication that the sidelink wake-up signal is associated with the second access link between the second UE and the network node.

In an eighth aspect, the explicit indication includes a bit in a bitfield that is set to a value that indicates the sidelink wake-up signal is associated with the second access link.

In a ninth aspect, process 800 includes transmitting, to the network node and using the first access link, an association indication that specifies the first UE and the second UE are associated based at least in part on the sidelink.

In a tenth aspect, process 800 includes transmitting, to the network node and using the first access link, a permission indication that specifies that the first UE agrees to be a relay UE.

In an eleventh aspect, process 800 includes receiving, prior to receiving the first indication of the access link wake-up signal, a relay mode indication that specifies the network node is activating relayed wake-up operations.

In a twelfth aspect, process 800 includes receiving, with the relay mode indication, one or more UE identifiers associated with the relayed wake-up operations.

In a thirteenth aspect, the one or more UE identifiers comprise at least one of a sidelink identifier, or a wake-up identifier.

In a fourteenth aspect, the first indication of the access link wake-up signal specifies to transition from an access link sleep mode to an access link active mode.

In a fifteenth aspect, process 800 includes transmitting, to the network node and using the first access link, a disassociation indication that specifies the UE and the second UE are disassociated.

In a sixteenth aspect, transmitting the disassociation indication includes transmitting a wake-up identifier assigned to the second UE.

In a seventeenth aspect, the wake-up identifier includes a temporary identifier assigned by the network node that obscures a network identity assigned to the second UE, or a sidelink identifier.

In an eighteenth aspect, process 800 includes receiving, from the network node and using the first access link, a relay mode indication that specifies the network node is deactivating relayed wake-up operations.

In a nineteenth aspect, process 800 includes refraining from relaying a second access link wake-up signal to the second UE based at least in part on receiving the relay mode indication associated with deactivating the relayed wake-up operations.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with a relayed wake-up signal for an access link using a sidelink.

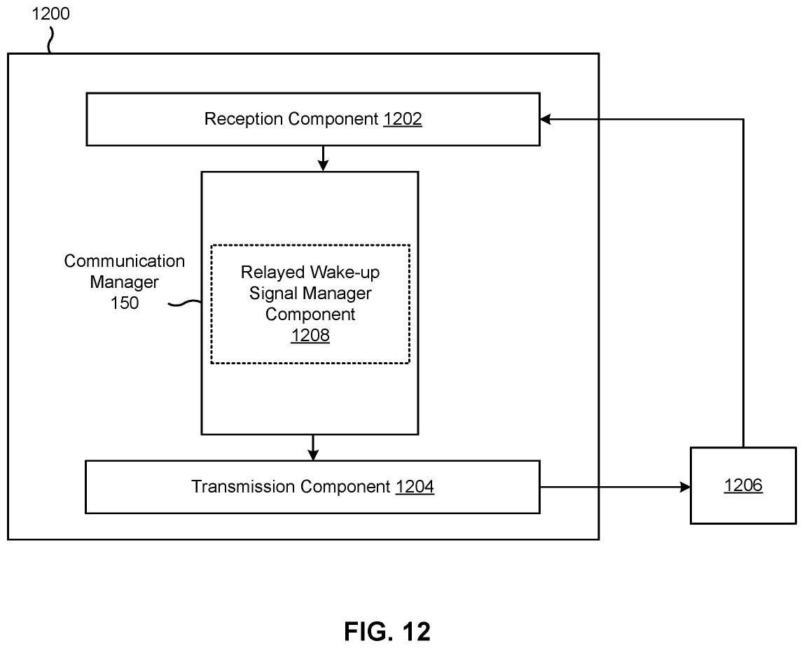

As shown in FIG. 9, in some aspects, process 900 may include transmitting, using a second access link that is associated with a second UE, an instruction to transition the second access link to a deep sleep mode (block 910). For example, the network node (e.g., using communication manager 150 and/or transmission component 1204, depicted in FIG. 12) may transmit, using a second access link that is associated with a second UE, an instruction to transition the second access link to a deep sleep mode, as described above.

As further shown in FIG. 9, in some aspects, process 900 may include transmitting, using a first access link and to a first UE that is associated with a sidelink between the first UE and the second UE, an indication of an access link wake-up signal associated with the second access link (block 920). For example, the network node (e.g., using communication manager 150 and/or transmission component 1204, depicted in FIG. 12) may transmit, using a first access link and to a first UE that is associated with a sidelink between the first UE and the second UE, an indication of an access link wake-up signal associated with the second access link, as described above.

Process 900 may include additional aspects, such as any single aspect or any combination of aspects described below and/or in connection with one or more other processes described elsewhere herein.

In a first aspect, process 900 includes receiving an association indication that specifies the first UE and the second UE are associated based at least in part on the sidelink.

In a second aspect, receiving the association indication further includes receiving the association indication from the first UE, or the second UE.

In a third aspect, the instruction to transition the second access link to the deep sleep mode indicates to retain the sidelink between the first UE and the second UE.

In a fourth aspect, process 900 includes transmitting, prior to transmitting the access link wake-up signal and to at least one of the first UE or the second UE, a wake-up identifier assigned to the second UE. In some aspects, the indication of the access link wake-up signal associated with the second UE includes the wake-up identifier assigned to the second UE.

In a fifth aspect, the wake-up identifier includes a temporary identifier that obscures a network identity assigned to the second UE.

In a sixth aspect, the network identity includes at least one of an international mobile subscriber identity, or an s-temporary mobile subscriber identity.

In a seventh aspect, the wake-up identifier is based at least in part on a mapping between an access link UE identifier and a sidelink identifier.

In an eighth aspect, the sidelink identifier is a Layer 1 sidelink identifier, a Layer 2 sidelink identifier, or a Layer 3 sidelink identifier.

In a ninth aspect, process 900 includes receiving, using the first access link, a permission indication that specifies that the first UE agrees to be a relay UE.

In a tenth aspect, process 900 includes transmitting, prior to transmitting the indication of the access link wake-up signal and to at least one of the first UE or the second UE, a relay mode indication that specifies activation of relayed wake-up operations.

In an eleventh aspect, the relay mode indication specifies one or more UE identifiers associated with activation of the relayed wake-up operations.

In a twelfth aspect, process 900 includes a sidelink identifier, or a wake-up identifier.

In a thirteenth aspect, transmitting the relay mode indication includes transmitting the relay mode indication to the second UE, and the relay mode indication specifies a sidelink identifier associated with the first UE.

In a fourteenth aspect, transmitting the instruction to transition the second access link to the deep sleep mode includes transmitting the instruction based at least in part on including the instruction in at least one of a radio resource control message, a MAC CE, or downlinking control information.

In a fifteenth aspect, the instruction to transition the second access link to the deep sleep mode is associated with an access link DRX periodicity that is independent from a sidelink DRX periodicity associated with the second UE.

In a sixteenth aspect, the access link DRX periodicity is longer than the sidelink DRX periodicity.

In a seventeenth aspect, the indication of the access link wake-up signal specifies to transition from an access link sleep mode to an access link active mode.

In an eighteenth aspect, process 900 includes receiving a disassociation indication that specifies the first UE and the second UE are disassociated.

In a nineteenth aspect, receiving the disassociation indication includes receiving the disassociation indication from the first UE and using the first access link.

In some aspects, the disassociation indication specifies a wake-up identifier assigned to the second UE.

In a twentieth aspect, the wake-up identifier includes a temporary identifier assigned by the network node that obscures a network identity assigned to the second UE, or a sidelink identifier associated with the second UE.

In a twenty-first aspect, receiving the disassociation indication includes receiving the disassociation indication from the second UE using the second access link and based at least in part on at least one of a random access channel transmission, or a grant-less transmission.

In a twenty-second aspect, receiving the disassociation indication includes receiving the disassociation indication based at least in part on the random access channel transmission, and the random access channel transmission indicates a reason for the second UE disassociating from the first UE.

In a twenty-third aspect, process 900 includes transmitting a relay mode indication that specifies deactivation of relayed wake-up operations.

In a twenty-fourth aspect, the transmitting includes at least one of transmitting the relay mode indication to the first UE using the first access link, or transmitting the relay mode indication to the second UE using the second access link.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a second UE, in accordance with the present disclosure. Example process 1000 is an example where the second UE (e.g., UE 120 and/or second UE 604-1) performs operations associated with a relayed wake-up signal for an access link using a sidelink.

As shown in FIG. 10, in some aspects, process 1000 may include receiving, from a network node and using an access link between the second UE and the network node, an instruction to transition the access link to a deep sleep mode (block 1010). For example, the second UE (e.g., using communication manager 140 and/or reception component 1102, depicted in FIG. 11) may receive, from a network node and using an access link between the second UE and the network node, an instruction to transition the access link to a deep sleep mode, as described above.

As further shown in FIG. 10, in some aspects, process 1000 may include receiving, from a first UE and using a sidelink between the first UE and the second UE, an indication of an access link wake-up signal associated with the access link (block 1020). For example, the second UE (e.g., using communication manager 140 and/or reception component 1102, depicted in FIG. 11) may receive, from a first UE and using a sidelink between the first UE and the second UE, an indication of an access link wake-up signal associated with the access link, as described above.

Process 1000 may include additional aspects, such as any single aspect or any combination of aspects described below and/or in connection with one or more other processes described elsewhere herein.

In a first aspect, process 1000 includes transmitting, to the network node using the access link and prior to receiving the instruction, an association indication that specifies the second UE and the first UE are associated based at least in part on the sidelink.

In a second aspect, the instruction to transition the access link to the deep sleep mode indicates to retain the sidelink with the first UE.

In a third aspect, process 1000 includes receiving, prior to receiving the instruction, a wake-up identifier assigned to the second UE.

In a fourth aspect, the wake-up identifier includes a temporary identifier that obscures a network identity assigned to the second UE.

In a fifth aspect, the network identity includes at least one of an international mobile subscriber identity, or an s-temporary mobile subscriber identity.

In a sixth aspect, the wake-up identifier is based at least in part on a mapping between an access link UE identifier and a sidelink identifier.

In a seventh aspect, the sidelink identifier is a Layer 1 sidelink identifier, a Layer 2 sidelink identifier, or a Layer 3 sidelink identifier.

In an eighth aspect, process 1000 includes receiving, prior to receiving the instruction and from the network node using the access link, a relay mode indication that specifies activation of relayed wake-up operations.

In a ninth aspect, the relay mode indication specifies one or more UE identifiers associated with activation of the relayed wake-up operations.

In a tenth aspect, process 1000 includes a sidelink identifier, or a wake-up identifier.

In an eleventh aspect, the one or more UE identifiers includes a sidelink identifier associated with the first UE.

In a twelfth aspect, receiving the instruction to transition the access link to the deep sleep mode includes receiving the instruction based at least in part on including the instruction in at least one of a radio resource control message, a MAC CE, or downlinking control information.

In a thirteenth aspect, the instruction to transition the access link is associated with an access link DRX periodicity that is independent from a sidelink DRX periodicity associated with second UE.

In a fourteenth aspect, the access link DRX periodicity is longer than the sidelink DRX periodicity.

In a fifteenth aspect, the indication of the access link wake-up signal specifies to transition from an access link sleep mode to an access link active mode.

In a sixteenth aspect, process 1000 includes transmitting, using the access link, a disassociation indication that specifies the first UE and the second UE are disassociated.

In a seventeenth aspect, transmitting the disassociation indication includes transmitting the disassociation indication based at least in part on at least one of a random access channel transmission, or a grant-less transmission.

In an eighteenth aspect, transmitting the disassociation indication includes transmitting the disassociation indication based at least in part on the random access channel transmission, and the random access channel transmission indicates a reason for the second UE disassociating from the first UE.

In a nineteenth aspect, the indication of the access link wake-up signal specifies a wake-up identifier associated with the second UE.

In a twentieth aspect, process 1000 includes decoding the wake-up identifier in the access link wake-up signal, identifying the wake-up identifier is associated with the second UE, and transitioning to an active mode based at least in part on identifying the wake-up identifier is associated with the second UE.

In a twenty-first aspect, in the indication of the access link wake-up signal includes a sidelink wake-up signal that includes an explicit indication that the sidelink wake-up signal is associated with the access link between the second UE and the network node.

In a twenty-second aspect, the explicit indication includes a bit in a bitfield being set to a value that indicates the sidelink wake-up signal is associated with the access link between the second UE and the network node.

In a twenty-third aspect, process 1000 includes decoding that the sidelink wake-up signal indicates to transition the access link to an active mode, and transitioning the access link to the active mode.

In a twenty-fourth aspect, process 1000 includes transitioning the access link to the deep sleep mode based at least in part on receiving the instruction.

In a twenty-fifth aspect, process 1000 includes transitioning the access link to an active mode based at least in part on receiving the access link wake-up signal.

In a twenty-sixth aspect, process 1000 includes receiving a relay mode indication that specifies the network node is deactivating relayed wake-up operations, and transitioning the access link to an active mode based at least in part on receiving the relay mode indication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., a UE 120), or a UE (e.g., a UE 120) may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a relayed wake-up signal manager component 1108, among other examples.

In some aspects, the apparatus 1100 may be configured to perform one or more operations described herein in connection with FIGS. 5-10. Additionally, or alternatively, the apparatus 1100 may be configured to perform one or more processes described herein, such as process 800 of FIG. 8, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The relayed wake-up signal manager component 1108 may receive, by way of the reception component 1102 and from a network node using a first access link, a first indication of an access link wake-up signal associated with a second access link between a second UE and the network node. The relayed wake-up signal manager component 1108 may transmit, by way of the transmission component 1104 and based at least in part on using a sidelink between the first UE and the second UE, a second indication of the access link wake-up signal to the second UE.

The relayed wake-up signal manager component 1108 may receive, by way of the reception component 1102 using the first access link and prior to receiving the access link wake-up signal from the network node, a wake-up identifier assigned to the second UE.

The relayed wake-up signal manager component 1108 may transmit, by way of the transmission component 1104 and to the network node using the first access link, an association indication that specifies the first UE and the second UE are associated based at least in part on the sidelink. Alternatively or additionally, the relayed wake-up signal manager component 1108 may transmit, by way of the transmission component 1104 and to the network node using the first access link, a permission indication that specifies that the first UE agrees to be a relay UE.

The relayed wake-up signal manager component 1108 may receive, by way of the reception component 1102 and prior to receiving the first indication of the access link wake-up signal, a relay mode indication that specifies the network node is activating relayed wake-up operations. Alternatively or additionally, the relayed wake-up signal manager component 1108 may receive, by way of the reception component 1102 and with the relay mode indication, one or more UE identifiers associated with the relayed wake-up operations.

The relayed wake-up signal manager component 1108 may transmit, by way of the transmission component 1104 and to the network node using the first access link, a disassociation indication that specifies the first UE and the second UE are disassociated. Alternatively or additionally, the relayed wake-up signal manager component 1108 may receive, by way of the reception component 1102 and from the network node using the first access link, a relay mode indication that specifies the network node is deactivating relayed wake-up operations. The relayed wake-up signal manager component 1108 may refrain from relaying a second access link wake-up signal to the second UE based at least in part on receiving the relay mode indication associated with deactivating the relayed wake-up operations.

In some aspects, such as in scenarios where the apparatus is associated with a second UE, the relayed wake-up signal manager component 1108 may receive, by way of the reception component 1102 and from a network node using an access link between the second UE and the network node, an instruction to transition the access link to a deep sleep mode. Alternatively or additionally, the relayed wake-up signal manager component 1108 may receive, by way of the reception component 1102 and from a first UE using a sidelink between the first UE and the second UE, an indication of an access link wake-up signal associated with the access link.

The relayed wake-up signal manager component 1108 may transmit, by way of the transmission component 1104 and to the network node using the access link prior to receiving the instruction, an association indication that specifies the second UE and the first UE are associated based at least in part on the sidelink. In some aspects, the relayed wake-up signal manager component 1108 may receive, by way of the reception component 1102 and prior to receiving the instruction, a wake-up identifier assigned to the second UE. Alternatively or additionally, the relayed wake-up signal manager component 1108 may receive, by way of the reception component 1102 and prior to receiving the instruction from the network node using the access link, a relay mode indication that specifies activation of relayed wake-up operations.

The relayed wake-up signal manager component 1108 may transmit, by way of the transmission component 1104 and using the access link, a disassociation indication that specifies the first UE and the second UE are disassociated.

In some aspects, the relayed wake-up signal manager component 1108 may decode the wake-up identifier in the access link wake-up signal. Alternatively or additionally, the relayed wake-up signal manager component 1108 may identify the wake-up identifier is associated with the second UE. In some aspects, the relayed wake-up signal manager component 1108 may transition to an active mode (e.g., an access link) based at least in part on identifying the wake-up identifier is associated with the second UE. Alternatively or additionally, the relayed wake-up signal manager component 1108 may decode that the sidelink wake-up signal indicates to transition the access link to an active mode.

In some aspects, the relayed wake-up signal manager component 1108 may transition the access link to the active mode. Alternatively or additionally, the relayed wake-up signal manager component 1108 may transition the access link to the deep sleep mode based at least in part on receiving the instruction. As one example, the relayed wake-up signal manager component 1108 may transition the access link to an active mode based at least in part on receiving the access link wake-up signal.

The relayed wake-up signal manager component 1108 may receive a relay mode indication that specifies the network node is deactivating relayed wake-up operations. Alternatively or additionally, the relayed wake-up signal manager component 1108 may transition the access link to an active mode based at least in part on receiving the relay mode indication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node (e.g., a network node 110), or a network node (e.g., a network node 110) may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a relayed wake-up signal manager component 1208, among other examples.

In some aspects, the apparatus 1200 may be configured to perform one or more operations described herein in connection with FIGS. 5-10. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The transmission component 1204 may transmit, using a second access link that is associated with a second UE, an instruction to transition the second access link to a deep sleep mode. The transmission component 1204 may transmit, using a first access link and to a first UE that is associated with a sidelink between the first UE and the second UE, an indication of an access link wake-up signal associated with the second access link.

The relayed wake-up signal manager component 1208 may receive, by way of the reception component 1202, an association indication that specifies the first UE and the second UE are associated based at least in part on the sidelink. Alternatively or additionally, the relayed wake-up signal manager component 1208 may receive, by way of the reception component 1202 and using the first access link, a permission indication that specifies that the first UE agrees to be a relay UE. In some aspects, the relayed wake-up signal manager component 1208 may receive, by way of the reception component 1202, a disassociation indication that specifies the first UE and the second UE are disassociated.

The relayed wake-up signal manager component 1208 may transmit, by way of the transmission component 1204 and prior to transmitting the access link wake-up signal (e.g., to at least one of the first UE or the second UE), a wake-up identifier assigned to the second UE. In some aspects, the relayed wake-up signal manager component 1208 may transmit, by way of the transmission component 1204 and prior to transmitting the indication of the access link wake-up signal (e.g., to at least one of the first UE or the second UE), a relay mode indication that specifies activation of relayed wake-up operations. Alternatively or additionally, the relayed wake-up signal manager component 1208 may transmit, by way of the transmission component 1204, a relay mode indication that specifies deactivation of relayed wake-up operations

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by an apparatus of a first user equipment (UE), comprising: receiving, from a network node and using a first access link, a first indication of an access link wake-up signal associated with a second access link between a second UE and the network node; and transmitting, based at least in part on using a sidelink between the first UE and the second UE, a second indication of the access link wake-up signal to the second UE.
Aspect 2: The method of Aspect 1, further comprising: receiving, using the first access link and prior to receiving the access link wake-up signal from the network node, a wake-up identifier assigned to the second UE.
Aspect 3: The method of Aspect 2, wherein the wake-up identifier comprises a temporary identifier that obscures a network identity assigned to the second UE.
Aspect 4: The method of Aspect 3, wherein the network identity comprises at least one of: an international mobile subscriber identity, or an s-temporary mobile subscriber identity.
Aspect 5: The method of any one of Aspects 2-4, wherein the second indication specifies the wake-up identifier.
Aspect 6: The method of any one of Aspects 2-5, wherein the wake-up identifier is based at least in part on a mapping between an access link UE identifier and a sidelink identifier, and the method further comprises: decoding the wake-up identifier to obtain the sidelink identifier, and wherein transmitting the second indication of the access link wake-up signal to the second UE comprises: transmitting the second indication of the access link wake-up signal to the second UE based at least in part on using the sidelink identifier.
Aspect 7: The method of Aspect 6, wherein the sidelink identifier is: a Layer 1 sidelink identifier, a Layer 2 sidelink identifier, or a Layer 3 sidelink identifier.
Aspect 8: The method of any one of Aspects 1-7, wherein the second indication of the access link wake-up signal comprises a sidelink wake-up signal that includes an explicit indication that the sidelink wake-up signal is associated with the second access link between the second UE and the network node.
Aspect 9: The method of Aspect 8, wherein the explicit indication comprises a bit in a bitfield that is set to a value that indicates the sidelink wake-up signal is associated with the second access link.
Aspect 10: The method of any one of Aspects 1-9, further comprising: transmitting, to the network node and using the first access link, an association indication that specifies the first UE and the second UE are associated based at least in part on the sidelink.
Aspect 11: The method of any one of Aspects 1-10, further comprising: transmitting, to the network node and using the first access link, a permission indication that specifies that the first UE agrees to be a relay UE.
Aspect 12: The method of any one of Aspects 1-11, further comprising: receiving, prior to receiving the first indication of the access link wake-up signal, a relay mode indication that specifies the network node is activating relayed wake-up operations.
Aspect 13: The method of Aspect 12, further comprising: receiving, with the relay mode indication, one or more UE identifiers associated with the relayed wake-up operations.
Aspect 14: The method of Aspect 13, wherein the one or more UE identifiers comprise at least one of: a sidelink identifier, or a wake-up identifier.
Aspect 15: The method of any one of Aspects 1-14, wherein the first indication of the access link wake-up signal specifies to transition from an access link sleep mode to an access link active mode.
Aspect 16: The method of any one of Aspects 1-15, further comprising:
transmitting, to the network node and using the first access link, a disassociation indication that specifies the first UE and the second UE are disassociated.
Aspect 17: The method of Aspect 16, wherein transmitting the disassociation indication comprises: transmitting a wake-up identifier assigned to the second UE.
Aspect 18: The method of Aspect 17, wherein the wake-up identifier comprises: a temporary identifier assigned by the network node that obscures a network identity assigned to the second UE, or a sidelink identifier.
Aspect 19: The method of any one of Aspects 1-18, further comprising:
receiving, from the network node and using the first access link, a relay mode indication that specifies the network node is deactivating relayed wake-up operations.
Aspect 20: The method of Aspect 19, further comprising: refraining from relaying a second access link wake-up signal to the second UE based at least in part on receiving the relay mode indication associated with deactivating the relayed wake-up operations.
Aspect 21: A method of wireless communication performed by an apparatus of a network node, comprising: transmitting, using a second access link that is associated with a second user equipment (UE), an instruction to transition the second access link to a deep sleep mode; and transmitting, using a first access link and to a first UE that is associated with a sidelink between the first UE and the second UE, an indication of an access link wake-up signal associated with the second access link.
Aspect 22: The method of Aspect 21, further comprising: receiving an association indication that specifies the first UE and the second UE are associated based at least in part on the sidelink.
Aspect 23: The method of Aspect 22, wherein receiving the association indication further comprises: receiving the association indication from: the first UE, or the second UE.
Aspect 24: The method of any one of Aspects 21-23, wherein the instruction to transition the second access link to the deep sleep mode indicates to retain the sidelink between the first UE and the second UE.
Aspect 25: The method of any one of Aspects 21-24, further comprising:
transmitting, prior to transmitting the access link wake-up signal and to at least one of the first UE or the second UE, a wake-up identifier assigned to the second UE; wherein the indication of the access link wake-up signal associated with the second UE includes the wake-up identifier assigned to the second UE. wherein the indication of the access link wake-up signal associated with the second UE includes the wake-up identifier assigned to the second UE.
Aspect 26: The method of Aspect 25, wherein the wake-up identifier comprises a temporary identifier that obscures a network identity assigned to the second UE.
Aspect 27: The method of Aspect 26, wherein the network identity comprises at least one of: an international mobile subscriber identity, or an s-temporary mobile subscriber identity.
Aspect 28: The method of any one of Aspects 25-27, wherein the wake-up identifier is based at least in part on a mapping between an access link UE identifier and a sidelink identifier.
Aspect 29: The method of Aspect 28, wherein the sidelink identifier is: a Layer 1 sidelink identifier, a Layer 2 sidelink identifier, or a Layer 3 sidelink identifier.
Aspect 30: The method of any one of Aspects 21-29, further comprising:
receiving, using the first access link, a permission indication that specifies that the first UE agrees to be a relay UE.
Aspect 31: The method of any one of Aspects 21-30, further comprising:
transmitting, prior to transmitting the indication of the access link wake-up signal and to at least one of the first UE or the second UE, a relay mode indication that specifies activation of relayed wake-up operations.
Aspect 32: The method of Aspect 31, wherein the relay mode indication specifies one or more UE identifiers associated with activation of the relayed wake-up operations.
Aspect 33: The method of Aspect 32 wherein the one or more UE identifiers comprise at least one of: a sidelink identifier, or a wake-up identifier.
Aspect 34: The method of any one of Aspects 31-33, wherein transmitting the relay mode indication comprises: transmitting the relay mode indication to the second UE, wherein the relay mode indication specifies a sidelink identifier associated with the first UE.
Aspect 35: The method of any one of Aspects 21-34, wherein transmitting the instruction to transition the second access link to the deep sleep mode comprises: transmitting the instruction based at least in part on including the instruction in at least one of: a radio resource control message, a medium access control (MAC) control element (CE), or downlink control information.
Aspect 36: The method of any one of Aspects 21-35, wherein the instruction to transition the second access link to the deep sleep mode is associated with an access link discontinuous reception (DRX) periodicity that is independent from a sidelink DRX periodicity associated with the second UE.
Aspect 37: The method of Aspect 36, wherein the access link DRX periodicity is longer than the sidelink DRX periodicity.
Aspect 38: The method of any one of Aspects 21-37, wherein the indication of the access link wake-up signal specifies to transition from an access link sleep mode to an access link active mode.
Aspect 39: The method of any one of Aspects 21-38, further comprising:
receiving a disassociation indication that specifies the first UE and the second UE are disassociated.
Aspect 40: The method of Aspect 39, wherein receiving the disassociation indication comprises: receiving the disassociation indication from the first UE and using the first access link, wherein the disassociation indication specifies a wake-up identifier assigned to the second UE.
Aspect 41: The method of Aspect 40, wherein the wake-up identifier comprises: a temporary identifier assigned by the network node that obscures a network identity assigned to the second UE, or a sidelink identifier associated with the second UE.
Aspect 42: The method of any one of Aspects 39-41, wherein receiving the disassociation indication comprises: receiving the disassociation indication from the second UE using the second access link and based at least in part on at least one of: a random access channel transmission, or a grant-less transmission.
Aspect 43: The method of Aspect 42, wherein receiving the disassociation indication comprises: receiving the disassociation indication based at least in part on the random access channel transmission, wherein the random access channel transmission indicates a reason for the second UE disassociating from the first UE.
Aspect 44: The method of any one of Aspects 21-43, further comprising: transmitting a relay mode indication that specifies deactivation of relayed wake-up operations.
Aspect 45: The method of Aspect 44, wherein the transmitting comprises at least one of: transmitting the relay mode indication to the first UE using the first access link; or transmitting the relay mode indication to the second UE using the second access link.
Aspect 46: A method of wireless communication performed by an apparatus of a second user equipment (UE), comprising: receiving, from a network node and using an access link between the second UE and the network node, an instruction to transition the access link to a deep sleep mode; and receiving, from a first UE and using a sidelink between the first UE and the second UE, an indication of an access link wake-up signal associated with the access link.
Aspect 47: The method of Aspect 46, further comprising: transmitting, to the network node using the access link and prior to receiving the instruction, an association indication that specifies the second UE and the first UE are associated based at least in part on the sidelink.
Aspect 48: The method of Aspect 46 or Aspect 47, wherein the instruction to transition the access link to the deep sleep mode indicates to retain the sidelink with the first UE.
Aspect 49: The method of any one of Aspects 46-48, further comprising:
receiving, prior to receiving the instruction, a wake-up identifier assigned to the second UE.
Aspect 50: The method of Aspect 49, wherein the wake-up identifier comprises a temporary identifier that obscures a network identity assigned to the second UE.
Aspect 51: The method of Aspect 50, wherein the network identity comprises at least one of: an international mobile subscriber identity, or an s-temporary mobile subscriber identity.
Aspect 52: The method of any one of Aspects 49-51, wherein the wake-up identifier is based at least in part on a mapping between an access link UE identifier and a sidelink identifier.
Aspect 53: The method of Aspect 52, wherein the sidelink identifier is: a Layer 1 sidelink identifier, a Layer 2 sidelink identifier, or a Layer 3 sidelink identifier.
Aspect 54: The method of any one of Aspects 46-53, further comprising:
receiving, prior to receiving the instruction and from the network node using the access link, a relay mode indication that specifies activation of relayed wake-up operations.
Aspect 55: The method of Aspect 54, wherein the relay mode indication specifies one or more UE identifiers associated with activation of the relayed wake-up operations.
Aspect 56: The method of Aspect 55 wherein the one or more UE identifiers comprise at least one of: a sidelink identifier, or a wake-up identifier.
Aspect 57: The method of Aspect 55 or Aspect 56, wherein the one or more UE identifiers includes a sidelink identifier associated with the first UE.
Aspect 58: The method of any one of Aspects 46-57, wherein receiving the instruction to transition the access link to the deep sleep mode comprises: receiving the instruction based at least in part on including the instruction in at least one of: a radio resource control message, a medium access control (MAC) control element (CE), or downlink control information.
Aspect 59: The method of any one of Aspects 46-58, wherein the instruction to transition the access link is associated with an access link discontinuous reception (DRX) periodicity that is independent from a sidelink DRX periodicity associated with second UE.
Aspect 60: The method of Aspect 59, wherein the access link DRX periodicity is longer than the sidelink DRX periodicity.
Aspect 61: The method of any one of Aspects 46-60, wherein the indication of the access link wake-up signal specifies to transition from an access link sleep mode to an access link active mode.
Aspect 62: The method of any one of Aspects 46-61, further comprising:
transmitting, using the access link, a disassociation indication that specifies the first UE and the second UE are disassociated.
Aspect 63: The method of Aspect 62, wherein transmitting the disassociation indication comprises: transmitting the disassociation indication based at least in part on at least one of: a random access channel transmission, or a grant-less transmission.
Aspect 64: The method of Aspect 63, wherein transmitting the disassociation indication comprises: transmitting the disassociation indication based at least in part on the random access channel transmission, wherein the random access channel transmission indicates a reason for the second UE disassociating from the first UE.
Aspect 65: The method of any one of Aspects 46-64, wherein the indication of the access link wake-up signal specifies a wake-up identifier associated with the second UE.
Aspect 66: The method of Aspect 65, further comprising: decoding the wake-up identifier in the access link wake-up signal; identifying the wake-up identifier is associated with the second UE; and transitioning to an active mode based at least in part on identifying the wake-up identifier is associated with the second UE.
Aspect 67: The method of any one of Aspects 46-66, where in the indication of the access link wake-up signal comprises a sidelink wake-up signal that includes an explicit indication that the sidelink wake-up signal is associated with the access link between the second UE and the network node.
Aspect 68: The method of Aspect 67, wherein the explicit indication comprises a bit in a bitfield being set to a value that indicates the sidelink wake-up signal is associated with the access link between the second UE and the network node.
Aspect 69: The method of Aspect 68, further comprises: decoding that the sidelink wake-up signal indicates to transition the access link to an active mode; and transitioning the access link to the active mode.
Aspect 70: The method of any one of Aspects 46-69, further comprising:
transitioning the access link to the deep sleep mode based at least in part on receiving the instruction.
Aspect 71: The method of any one of Aspects 46-70, further comprising:
transitioning the access link to an active mode based at least in part on receiving the access link wake-up signal.
Aspect 72: The method of any one of Aspects 46-72, further comprising:
receiving a relay mode indication that specifies the network node is deactivating relayed wake-up operations; and transitioning the access link to an active mode based at least in part on receiving the relay mode indication.
Aspect 73: An apparatus for wireless communication at a device, comprising a processor; memory coupled with the processor; and instructions stored in the memory and executable by the processor to cause the apparatus to perform the method of one or more of Aspects 1-20.
Aspect 74: An apparatus for wireless communication at a device, comprising a processor; memory coupled with the processor; and instructions stored in the memory and executable by the processor to cause the apparatus to perform the method of one or more of Aspects 21-45.
Aspect 75: An apparatus for wireless communication at a device, comprising a processor; memory coupled with the processor; and instructions stored in the memory and executable by the processor to cause the apparatus to perform the method of one or more of Aspects 46-72.
Aspect 76: A device for wireless communication, comprising a memory and one or more processors coupled to the memory, the one or more processors configured to perform the method of one or more of Aspects 1-20.
Aspect 77: A device for wireless communication, comprising a memory and one or more processors coupled to the memory, the one or more processors configured to perform the method of one or more of Aspects 21-45.
Aspect 78: A device for wireless communication, comprising a memory and one or more processors coupled to the memory, the one or more processors configured to perform the method of one or more of Aspects 46-72.
Aspect 79: An apparatus for wireless communication, comprising at least one means for performing the method of one or more of Aspects 1-20.
Aspect 80: An apparatus for wireless communication, comprising at least one means for performing the method of one or more of Aspects 21-45.
Aspect 81: An apparatus for wireless communication, comprising at least one means for performing the method of one or more of Aspects 46-72.
Aspect 82: A non-transitory computer-readable medium storing code for wireless communication, the code comprising instructions executable by a processor to perform the method of one or more of Aspects 1-20.
Aspect 83: A non-transitory computer-readable medium storing code for wireless communication, the code comprising instructions executable by a processor to perform the method of one or more of Aspects 21-45.
Aspect 84: A non-transitory computer-readable medium storing code for wireless communication, the code comprising instructions executable by a processor to perform the method of one or more of Aspects 46-72.
Aspect 85: A non-transitory computer-readable medium storing a set of instructions for wireless communication, the set of instructions comprising one or more instructions that, when executed by one or more processors of a device, cause the device to perform the method of one or more of Aspects 1-20.
Aspect 86: A non-transitory computer-readable medium storing a set of instructions for wireless communication, the set of instructions comprising one or more instructions that, when executed by one or more processors of a device, cause the device to perform the method of one or more of Aspects 21-45.
Aspect 87: A non-transitory computer-readable medium storing a set of instructions for wireless communication, the set of instructions comprising one or more instructions that, when executed by one or more processors of a device, cause the device to perform the method of one or more of Aspects 46-72.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
a processor
a memory coupled to the processor; and
instructions stored in the memory that are executable by the processor to cause the apparatus to:
receive, from a network node and using a first access link, a first indication of an access link wake-up signal associated with a second access link between a second UE and the network node; and
transmit, based at least in part on using a sidelink between the first UE and the second UE, a second indication of the access link wake-up signal to the second UE.

2. The apparatus of claim 1, wherein the memory includes instructions that are executable by the processor to cause the apparatus to:
receive, using the first access link and prior to receiving the access link wake-up signal from the network node, a wake-up identifier assigned to the second UE.

3. The apparatus of claim 2, wherein the memory includes instructions that are executable by the processor to cause the apparatus to:
decode the wake-up identifier to obtain a sidelink identifier, and
wherein instructions, to transmit the second indication of the access link wake-up signal to the second UE, are executable by the processor to cause the apparatus to:
transmit the second indication of the access link wake-up signal to the second UE based at least in part on using the sidelink identifier.

4. The apparatus of claim 1, wherein the second indication of the access link wake-up signal comprises a sidelink wake-up signal that includes an explicit indication that the sidelink wake-up signal is associated with the second access link between the second UE and the network node.

5. The apparatus of claim 1, wherein the memory includes instructions that are executable by the processor to cause the apparatus to:
transmit, to the network node and using the first access link, an association indication that specifies the first UE and the second UE are associated based at least in part on the sidelink.

6. The apparatus of claim 1, wherein the memory includes instructions that are executable by the processor to cause the apparatus to:
transmit, to the network node and using the first access link, a permission indication that specifies that the first UE agrees to be a relay UE.

7. The apparatus of claim 1, wherein the memory includes instructions that are executable by the processor to cause the apparatus to:
receive, prior to receiving the first indication of the access link wake-up signal, a relay mode indication that specifies the network node is activating relayed wake-up operations.

8. The apparatus of claim 1 wherein the memory includes instructions that are executable by the processor to cause the apparatus to:
transmit, to the network node and using the first access link, a disassociation indication that specifies the first UE and the second UE are disassociated.

9. The apparatus of claim 1, wherein the memory includes instructions that are executable by the processor to cause the apparatus to:
receive, from the network node and using the first access link, a relay mode indication that specifies the network node is deactivating relayed wake-up operations.

10. An apparatus for wireless communication at a network node, comprising:
a processor
a memory coupled to the processor; and
instructions stored in the memory that are executable by the processor to cause the apparatus to:
transmit, using a second access link that is associated with a second user equipment (UE), an instruction to transition the second access link to a deep sleep mode; and
transmit, using a first access link and to a first UE that is associated with a sidelink between the first UE and the second UE, an indication of an access link wake-up signal associated with the second access link.

11. The apparatus of claim 10, wherein the memory includes instructions that are executable by the processor to cause the apparatus to:
receive an association indication that specifies the first UE and the second UE are associated based at least in part on the sidelink.

12. The apparatus of claim 10, wherein the memory includes instructions that are executable by the processor to cause the apparatus to:
transmit, prior to transmitting the access link wake-up signal and to at least one of the first UE or the second UE, a wake-up identifier assigned to the second UE;
wherein the indication of the access link wake-up signal associated with the second UE includes the wake-up identifier assigned to the second UE.

13. The apparatus of claim 10, wherein the memory includes instructions that are executable by the processor to cause the apparatus to:
receive, using the first access link, a permission indication that specifies that the first UE agrees to be a relay UE.

14. The apparatus of claim 10, wherein the memory includes instructions that are executable by the processor to cause the apparatus to:
transmit, prior to transmitting the indication of the access link wake-up signal and to at least one of the first UE or the second UE, a relay mode indication that specifies activation of relayed wake-up operations.

15. The apparatus of claim 10, wherein the instruction to transition the second access link to the deep sleep mode is associated with an access link discontinuous reception (DRX) periodicity that is independent from a sidelink DRX periodicity associated with the second UE.

16. The apparatus of claim 10, wherein the memory includes instructions that are executable by the processor to cause the apparatus to:
receive a disassociation indication that specifies the first UE and the second UE are disassociated.

17. The apparatus of claim 16, wherein the memory includes instructions that are executable by the processor to cause the apparatus to:
receive the disassociation indication from the second UE using the second access link and based at least in part on at least one of:
a random access channel transmission, or
a grant-less transmission.

18. An apparatus for wireless communication at a second user equipment (UE), comprising:
a processor
a memory coupled to the processor; and
instructions stored in the memory that are executable by the processor to cause the apparatus to:
receive, from a network node and using an access link between the second UE and the network node, an instruction to transition the access link to a deep sleep mode; and
receive, from a first UE and using a sidelink between the first UE and the second UE, an indication of an access link wake-up signal associated with the access link.

19. The apparatus of claim 18, wherein the memory includes instructions that are executable by the processor to cause the apparatus to:
transmit, to the network node using the access link and prior to receiving the instruction, an association indication that specifies the second UE and the first UE are associated based at least in part on the sidelink.

20. The apparatus of claim 18, wherein the memory includes instructions that are executable by the processor to cause the apparatus to:
receive, prior to receiving the instruction, a wake-up identifier assigned to the second UE.

21. The apparatus of claim 18, wherein the memory includes instructions that are executable by the processor to cause the apparatus to:
receive, prior to receiving the instruction and from the network node using the access link, a relay mode indication that specifies activation of relayed wake-up operations.

22. The apparatus of claim 18, wherein the instruction to transition the access link is associated with an access link discontinuous reception (DRX) periodicity that is independent from a sidelink DRX periodicity associated with second UE.

23. The apparatus of claim 18, where in the indication of the access link wake-up signal comprises a sidelink wake-up signal that includes an explicit indication that the sidelink wake-up signal is associated with the access link between the second UE and the network node.

24. The apparatus of claim 23, wherein the explicit indication comprises a bit in a bitfield being set to a value that indicates the sidelink wake-up signal is associated with the access link between the second UE and the network node.

25. A method of wireless communication performed by an apparatus of a first user equipment (UE), comprising:
receiving, from a network node and using a first access link, a first indication of an access link wake-up signal associated with a second access link between a second UE and the network node; and
transmitting, based at least in part on using a sidelink between the first UE and the second UE, a second indication of the access link wake-up signal to the second UE.

26. The method of claim 25, wherein the second indication of the access link wake-up signal comprises a sidelink wake-up signal that includes an explicit indication that the sidelink wake-up signal is associated with the second access link between the second UE and the network node.

27. The method of claim 25, further comprising:
transmitting, to the network node and using the first access link, an association indication that specifies the first UE and the second UE are associated based at least in part on the sidelink.

28. The method of claim 25, further comprising:
transmitting, to the network node and using the first access link, a permission indication that specifies that the first UE agrees to be a relay UE.

29. The method of claim 25, further comprising:
receiving, from the network node and using the first access link, a relay mode indication that specifies the network node is deactivating relayed wake-up operations.

30. The method of claim 29, further comprising:
refraining from relaying a second access link wake-up signal to the second UE based at least in part on receiving the relay mode indication associated with deactivating the relayed wake-up operations.
